(19) United States
(12) Patent Application Publication
(10) Pub. No.: US 2004/0246885 A1
(43) Pub. Date: Dec. 9, 2004

(54) Bus structure for bus grounding wires

(75) Inventor: Chiang Chin Chih, Taipei (TW)

Correspondence Address: BRUCE H. TROXELL, SUITE 1404, 5205 LEESBURG PIKE, FALLS CHURCH, VA, 22041, US

(73) Assignee: Hung Fu Group of Companies

(21) Appl. No.: 10/453,642

(22) Filed: Jun. 4, 2003

(51) Int. Cl. H04J 15/00

(52) U.S. Cl. 370/200

(57) ABSTRACT

An improved bus structure for bus grounding wires is composed of several parallel arrayed bus wires in a bus structure totally enclosed with an insulation layer, and several grounding wires in the bus structure are formed integrally in one piece with the bus structure together with the bus wires by extrusion process so as to skim on a further extra process to follow thereby saving the overall production cost.

### BACKGROUND OF THE INVENTION

1. Field of the Invention

The present invention relates to an improved bus structure for bus, grounding wires, and more particularly, to bus grounding wires, which are extruded integrally with the whole bus structure so as to skim on extra fabrication process and save the production cost.

2. Description of the Prior Art

Following the amazing progress of electronic technology, the trend of demand for precision and compactness of electronic products becomes more and more strict in order to keep pace with the progress of this leading industry in order to minimize the size of the products thereby reducing the production cost and curtail the related overhead expense.

Presently, the bus structure is one of the best devices of transmitting the signal for sophisticated electronic systems.

A conventional bus structure for electronic system is shown in FIG. 1. As shown in FIG. 1, a bus structure is basically composed of several parallel arrayed wires 11, 12, 13 . . . enclosed with an insulation layer 2. Electronic loads, when in use, are connected to output terminals of the bus structure so as to transmit signals.

However, the bus structure constructed as such is unable to be liberated from external electromagnetic interference resulting in degrading the quality of signal transmitted, or lowering efficiency of detection for electromagnetic waves owing to leakage of the same. In view of this, manufacturers of the bus structure have been tackling with this problem trying to find out remedies against it. One of them is bonding a metallic shield layer at each end of the bus structure using a binder. Or, as Pat. No. 456764 published in Patent Gazette of Taiwan, wherein extending a grounding terminal from each of the pins at both ends of the bus structure, and then applying a shield layer of fused silver on its end. Similarly, a complete shield layer of fused silver is formed at each side surface of the bus structure. It should be noted that such an installation of grounding wire has to be carried out after being accomplished extrusion of the bus wires as an extra fabrication process. However, any conventional techniques including aforementioned Pat. No. 456764 involve some disadvantages as easy exfoliation of the bonded metallic shield layer from the bus structure, loosing the flexibility of the bus wires by over-tightened bonding of the metallic shield layer to the bus structure, or requiring an extra fabrication process for installation of a grounding wire after completing the bus wire extrusion etc., all the factors combine to degrade quality and increase cost of the bus structure production.

It is what the reason the inventor has endeavored for years by continuous research and experimentation attempting to find out the remedies to rectify the inherent shortcomings of the conventional techniques described above, and at last has succeeded in realizing the present invention.

### SUMMARY OF THE INVENTION

Accordingly, it is an object of the present invention to provide an improved structure for bus grounding wire which can be formed by extruding integrally with the entire bus structure.

It is another object of the present invention to provide an improved structure for bus grounding wire which can avoid external electromagnetic interference and internal leakage of signal current.

To achieve the above objects, the present invention provides an improved structure for bus grounding wire in which the grounding wires are set at the predetermined positions in a die cavity together with the entire bus structure so as to be integrally formed by extrusion with the bus structure. Furthermore, the grounding wires are formed at both upper and lower sides of the bus wires so as to adjust size and position of the same freely and properly thereby avoiding external electromagnetic interference and internal leakage of signal current.

### BRIEF DESCRIPTION OF THE DRAWINGS

The above objects and other advantages of the present invention will become more apparent by describing in detail the preferred embodiment of the present invention with reference to the attached drawings in which:

FIG. 1 is a there-dimensional view of a conventional bus structure;

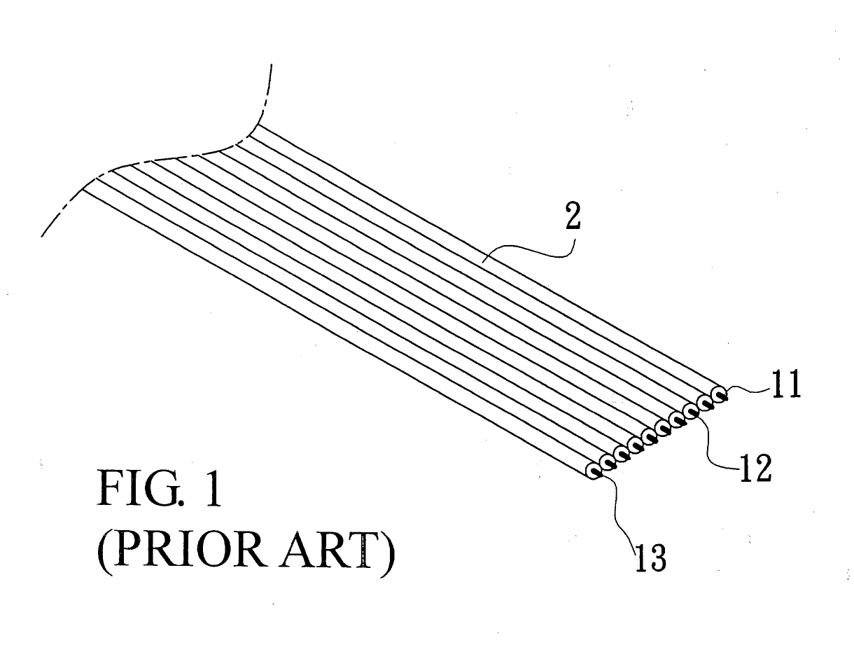

FIG. 2 is a perspective view of the present invention;

FIG. 3 is a three-dimensional view illustrating process of forming the present invention;

FIG. 4 is a perspective view showing the molding die of the present invention;

FIG. 5 is a perspective view in another embodiment of the present invention.

### DETAILED DESCRIPTION OF THE PREFERRED EMBODIMENTS

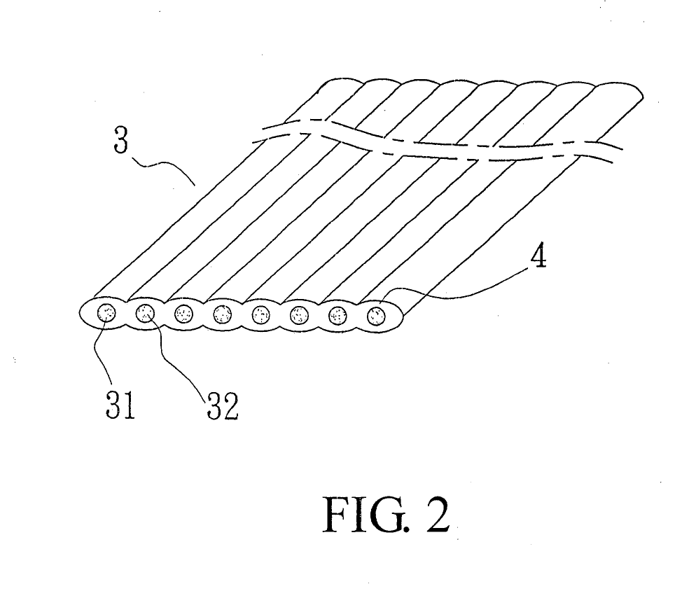

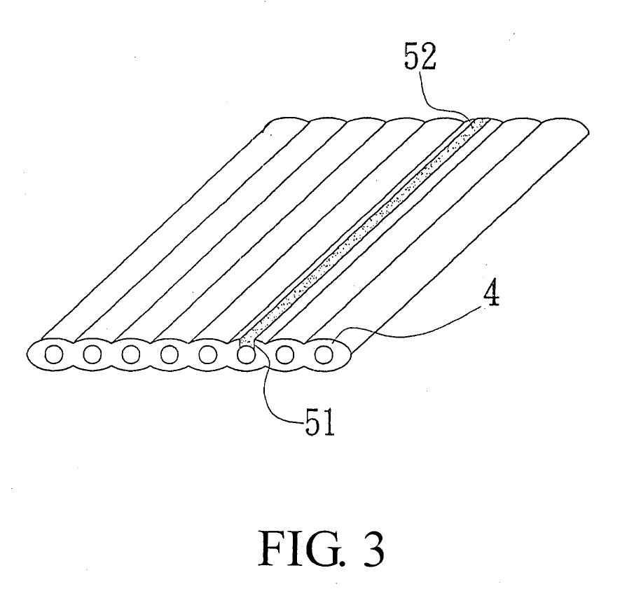

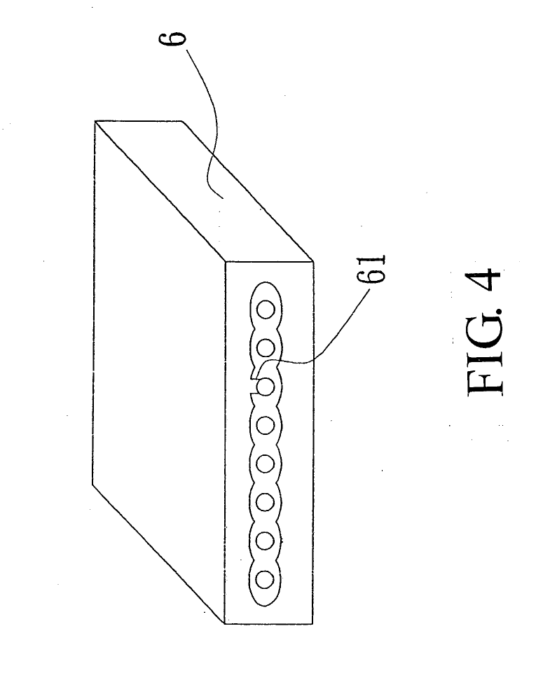

Referring to FIG. 2, a perspective view of the present invention wherein several bus wires 31, 32 . . . are parallel arrayed in a bus structure 3 enclosed with an insulation layer 4. Referring to FIG. 3, the predetermined position reserved for a grounding wire in the bus structure 3 is formed into a concaved ditch 51 which is uncovered with the insulation layer 4 when enclosing the bus structure 3 with the insulation layer 4. After being finished enclosing the bus structure 3 with the insulation layer 4, the reserved vacancy of the concaved ditch 51 is filled with a bus grounding wire 52. Then afterwards, the grounding wire 52 is formed integrally in one piece with the bus structure 3 together with the bus wires 31, 32 . . . thereof. Further referring to FIG. 4, in this perspective view showing the molding die 6 of the present invention, a concave ditch 61 reserved for accommodating the bus grounding wire 52 can be clearly observed.

Thus, if the bus grounding wire is integrally formed in one piece with the bus structure together with the bus wires, it is no more necessary for further fabrication process to follow so that the production cost can be curtailed.

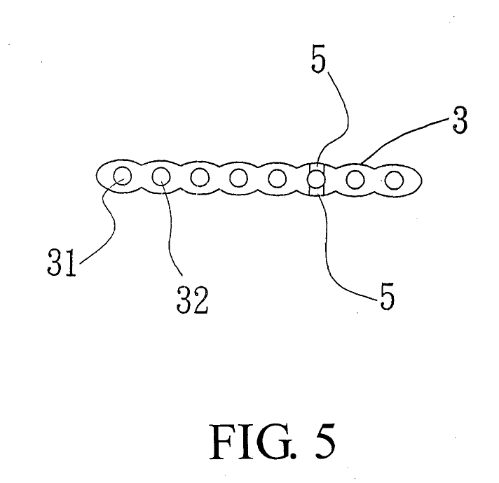

In another embodiment of the present invention shown in FIG. 5, wherein: grounding wires and the bus wires are formed integrally in one piece by extrusion. As it is clearly shown in FIG. 5, the grounding wires 5 are closely arrayed on upper and beneath lower sides of the bus wire 31 (32). Desired size and position for the grounding wire can be modified and adjusted at random on the molding die so as to avoid electromagnetic interference or leakage of signal current.

From the above description, it is understood that the present invention has several noteworthy advantages that the bus grounding wires can be formed by extruding integrally in one piece with the entire bus structure together with the bus wires, and no further fabrication process is needed. Furthermore, the grounding wires are formed at both upper and lower sides of the bus wires so that it is easy to adjust size and position of the same freely by modifying the molding die thereby avoiding external electromagnetic interference and internal leakage of signal current.

Those who are skilled in the art will readily perceive how to modify the invention. Therefore, the appended claims are to be construed to cover all equivalent structures which fall within the true scope and spirit of the invention.

What is claimed is:

1. Improved bus structure for bus grounding wires wherein several bus wires being parallel arrayed in a bus structure totally enclosed with an insulation layer, and several grounding wires in said bus structure being formed integrally in one piece with said bus structure together with said bus wires by extrusion process so as to skim on a further extra process to follow so that overall production cost can be curtailed.

2. The bus structure as in claim 1, wherein each of said bus grounding wires is formed on the upper and beneath the lower sides of each of said bus wires;

3. The bus structure as in claim 1, wherein the desired size and position for forming said bus grounding wire is performed by controlling the size and position on a molding die corresponding to a concaved ditch formed on said bus structure which accommodates said grounding wire.
